(19) United States
(12) Patent Application Publication
(10) Pub. No.: US 2019/0236673 A1
(43) Pub. Date: Aug. 1, 2019

(54) INTERACTICE METHOD AND INTERACTIVE SYSTEM FOR THE CREATION OF FLORAL ARRANGEMENTS

(71) Applicants: Fred Kassman, Newport Beach, CA (US); Ingrid Kassman, Newport Beach, CA (US)

(72) Inventors: Fred Kassman, Newport Beach, CA (US); Ingrid Kassman, Newport Beach, CA (US)

(21) Appl. No.: 16/262,503

(22) Filed: Jan. 30, 2019

Related U.S. Application Data
(60) Provisional application No. 62/623,896, filed on Jan. 30, 2018.

(51) Int. Cl. G06Q 30/06; G06F 17/24

(52) U.S. Cl. CPC G06Q 30/0621; G06F 17/248; G06Q 30/0641; G06Q 30/0611

(57) ABSTRACT

A method and system for providing a customized floral arrangement. The method and system allow for the creation of personalized floral arrangements based on inputted parameters, and may include providing to the user for selection, via an integrated network system, a plurality of floral arrangements and a plurality of flower choices. The system then creates at least one floral arrangement based on the received arrangement parameters, provides the arrangement to the user via any suitable electronic mechanism, and provides a list of local florists from which the user may pick and choose which florists to submit a bid to. The user then receives a quote from each florist who participates, after which the user may then select a desired florist to prepare the desired floral arrangement.

### CROSS REFERENCE TO RELATED APPLICATIONS

This Application claims the benefit of and priority to U.S. Provisional Patent Application No. 62/623,896, filed on Jan. 30, 2018, which is incorporated herein by reference in its entirety.

### FIELD OF USE

The present disclosure relates generally to floral arrangements and more specifically to methods and systems for the creation of floral arrangements.

### BACKGROUND

The current wedding floral arrangement industry is very fragmented, cumbersome and stressful. It is difficult for couples and florists to efficiently connect, create and evaluate flower packages in a timely fashion. The wedding and florist industry also consists of hundreds of thousands of small business that have limited technology knowledge and limited access to customers.

Furthermore, the current use of the Internet is very limited in the wedding floral segment. Websites currently only offer the ability to purchase pre-made floral arrangements, centerpieces, and bouquets for gift-giving and special occasions. These websites do not allow for an individual to customize an arrangement, centerpiece, or bouquet, or any combination of these. Current methods for floral arrangement offer very few choices in the arrangement of flowers or the ability to pick and choose an arrangement based on flower types. This presents an opportunity to maximize technology in a much more effective way to pair brides, grooms, and/or couples with florists, to provide a greater variety of and freedom in choosing floral arrangements, and to also create a pleasant experience with greater efficiency and lower cost transactions.

Thus, what is needed is a new and/or improved method and system that allows individuals the ability to interactively create personalized floral arrangements and connect with florists who may provide the desired floral arrangements.

### SUMMARY

The following presents a simplified overview of the example embodiments in order to provide a basic understanding of some embodiments of the present disclosure. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

In accordance with the embodiments disclosed herein, the present disclosure is directed to an interactive method and system for providing customized floral arrangements. The method and system allow for the creation of personalized floral arrangements based on inputted parameters such as a wedding color scheme and wedding venue location. The method and system may include providing to the user for selection, via an integrated network system, a plurality of floral arrangements, such as wedding bouquets, centerpieces, ceremony flowers, personal flowers, and other customized special floral arrangements desired the user. The method and system may also provide within the plurality of floral arrangements, flower choices to a user, and receiving at least one parameter with respect to the floral arrangement. The parameters for the flower choices may include, but are not limited to, type of flowers, color of flowers, number of flowers, type of arrangement, and size of arrangement. The system then creates at least one floral arrangement based on the received arrangement parameters and provides the arrangement to the user via any suitable mechanism, such as a mobile cellular device, personal smart devices, laptops, computers, and the like. The user is then presented with a list of local florists, based on the wedding venue location, who may supply the desired floral arrangements. The user may pick and choose to which florists to submit a bid. These chosen florists will each receive an electronic communication of the requested bid, after which the selected florist(s) may provide a quote for the preparation of the desired floral arrangement. The user may receive the quote from each florist who participates, after which the user may then select a desired florist to prepare the desired floral arrangement.

While the systems and methods of the present disclosure are described with respect to creating floral arrangements for weddings, it is to be understood that the systems and methods may be implement in creating floral arrangements for any event or situation. For example, the systems and methods may be used to create floral arrangements for corporate events, anniversaries, baby showers, birthdays, and the like.

Further features and advantages of the invention, as well as the structure and operation of various exemplary embodiments of the invention, are described in detail below with reference to the accompanying drawings.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an overview of an exemplary systems and methods for creating personalized floral arrangements according to the current disclosure.

FIG. 2 is a block diagram illustrating an example system environment for creating personalized floral arrangements according to the current disclosure.

FIG. 3 illustrates an exemplary user interface for the creation of a floral arrangement based on a bouquet template in accordance with an exemplary embodiment of the current disclosure.

FIG. 4 illustrates an exemplary user interface for the creation of a floral arrangement based on a bouquet template in accordance with an exemplary embodiment of the current disclosure.

FIG. 5 illustrates an exemplary system diagram for providing a floral arrangement creation engine in accordance with an exemplary embodiment of the current disclosure.

FIG. 6 illustrates an exemplary flowchart of the creation of a floral arrangement based on a bouquet template in accordance with an exemplary embodiment of the current disclosure.

FIG. 7 illustrates an exemplary user interface for receiving a selection of a focal flower in accordance with an exemplary embodiment of the current disclosure.

FIG. 8 illustrates an exemplary user interface for receiving a selection of florists and a quoting engine system for generating a price quote in accordance with an exemplary embodiment of the current disclosure.

FIG. 9 illustrates an example price quote for a selected floral arrangement.

FIG. 10 illustrates an exemplary user interface for receiving price quotes from a plurality of florists in accordance with an exemplary embodiment of the current disclosure.

FIG. 11 illustrates an exemplary user interface for submitting an order for a selected floral arrangement in accordance with an embodiment of the current disclosure.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the Specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, compact discs, read-only-memory (CD-ROMs), optical storage devices, or magnetic storage devices.

Embodiments of the methods and systems are described below with reference to graphical user interfaces (GUI) and flowchart illustrations of methods, systems, apparatuses and computer program products. It will be understood that each GUI and flowchart illustration, and combinations of GUIs and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, GUIs and flowchart illustrations support combinations of means for performing the specified functions, combinations of steps for performing the specified functions and program instruction means for performing the specified functions. It will also be understood that each GUI and flowchart illustrations, and combinations of GUIs and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

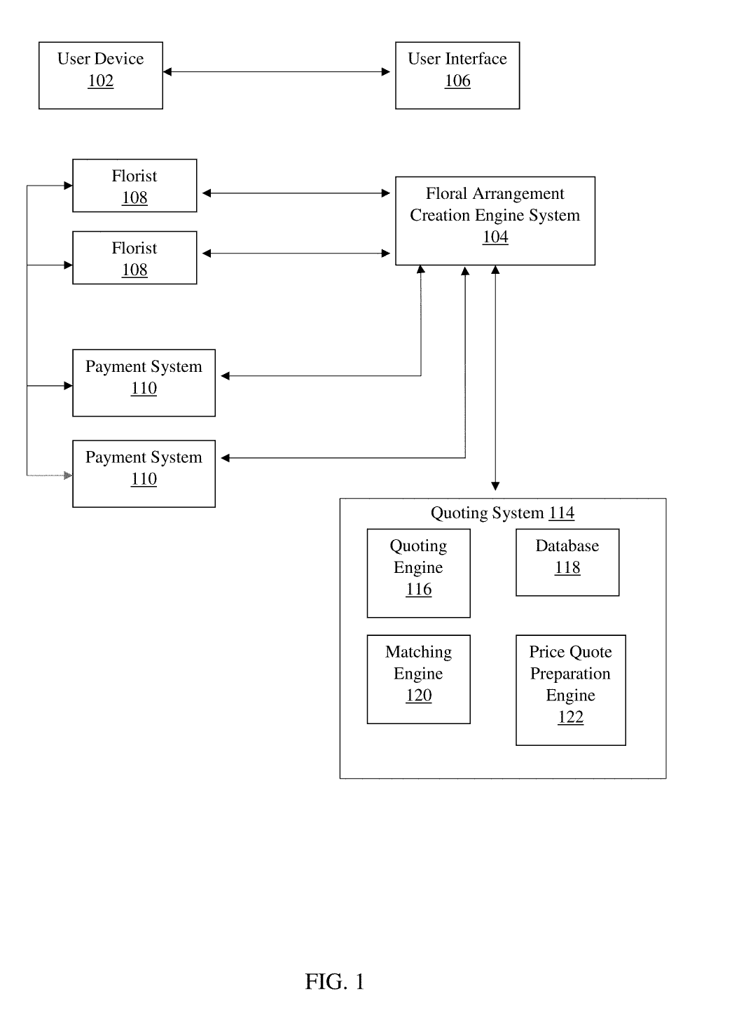

In some embodiments, the present disclosure provides processes, systems, and methods for providing personalized floral arrangements for a user based on creative input provided by the user. FIG. 1 provides an overview 100 of exemplary systems and methods for creating personalized floral arrangements according to the present disclosure. The process comprises obtaining a plurality of specific floral arrangement parameters from a user via a user device as shown at 102. The user provides the plurality of specific floral arrangement parameter to a floral arrangement creation engine system 104.

In one embodiment, the floral arrangement creation engine system 104 may provide a user interface 106, which interacts with user device associated with the user. In an exemplary embodiment, the user interface 106 may be a web interface. According to an exemplary embodiment, the user may input their name(s), date of ceremony, venue location, and chosen color scheme. This information, specifically the color scheme, as a point of reference for when the floral arrangement is created. The floral arrangement creation engine system 104, then provides to the user, via the user interface 106, a plurality of floral arrangements; such as wedding bouquets, centerpieces, ceremony flowers, personal flowers, and other customized special floral arrangements desired the user. The user selects which floral arrangement to create and design. Upon selection of the desired floral arrangement, the floral arrangement creation engine system 104 displays, via the user interface 106, a template of the selected floral arrangement and provides a plurality of flower choices parameters with which to alter the template, thus creating the personalized floral arrangement. The flower choices parameters may include, but are not limited to, type of flowers, color of flowers, number of flowers, type of arrangement, and size of arrangement.

According to an exemplary embodiment, the floral arrangement creation engine system 104 may generate the floral arrangement based on the received user arrangement parameters. In an exemplary embodiment, the floral arrangement creation engine system 104 may provide the generated flower arrangement to the user. According to an exemplary embodiment, the floral arrangement creation engine system 104 may provide the flower arrangement via displaying a representation of the generated floral arrangement on a personal computing device of the user.

After providing the floral arrangement, flower arrangement creation engine system 104 may continue with the option to choose from a plurality of florists 108 and/or payment options or systems 110. In choosing a florist and/or payment options, the floral arrangement creation engine system 104 may provide a plurality of florists 108 capable of preparing the desired floral arrangement, receive payment via a selected payment system 110 from a user for purchasing an actual floral arrangement based on the floral arrangement generated based on the floral arrangement parameters received from the user.

In an exemplary embodiment, a plurality of florists 108 may be based on the designed floral arrangement, budget restrictions, proximity to the user, and offered discounts. Payment options 110 may be forms of payments, such as, e.g., but not limited to, credit card, cellular phone applications, PayPal, gift certificate, or bank account, etc. According to an exemplary embodiment, the floral arrangement creation engine system 104 may present the user one or more of the above options of payment and the user may select one or more forms of payment using one or more of the options available from the floral arrangement creation engine system 104.

After receiving a florist selection and payment option, the floral arrangement creation engine system 104 may present available shipping and/or delivery options 112 for shipping the purchased floral arrangement to the user. In an exemplary embodiment, shipment options may include, such as, e.g., but not limited to, destination address, shipment carrier, shipment service type, signature requirement, or shipping insurance, etc. In one embodiment, the shipment options may allow the user to select tracking options for the shipment, such global positioning tracking and video monitoring.

The exemplary system 100 may further include a quoting system 114 for determining a pricing scheme for the desired floral arrangement based on the floral arrangement parameters received from the user, generating a price quote based on the determined pricing scheme, and providing the generated quote to the user. The quoting system 114 includes a quoting engine 116, database 118, a matching engine 120, and a price quote preparation engine 122.

The database 116 stores information concerning various florists 108 and their product availability. Furthermore, the database 116 may store geographical maps, floral arrangements, information from florists 108, florist pricing rules, florist incentives, and communication templates. Such incentives may include, but are not limited to, money-back guarantees, cancellation insurance, promotional offers, and the like. The database 118 may include various translations understood to be a particular floral arrangement by the quoting system 114. Once an incoming price quote request is received from the user, a product description may be identified in the request and matched to a product description of one or more florists 108 by the matching engine 120. The price quote preparation engine 122 then prepares the corresponding price quote for presentation to the user.

The interaction between the user and a selected florist may be an iterative process such that the user and the selected florist may work together to modify or refile a selected floral arrangement. For example, a user may select a particular florist based on the florist's location, reputation, pricing, expertise, and the like. However, the price quote received from the particular florist may not be ideal or within the user's allotted budget. The user and the florist may then work together using the floral arrangement creation engine system 104 to create other floral arrangements based on the user's provided floral arrangement parameters. This allows the user to benefit from the florist's expertise to provide additional alternatives in real or almost real time using the functionality of the floral arrangement creation engine system 104.

While the systems and methods of the present disclosure are described with respect to creating floral arrangements for weddings, it is to be understood that the systems and methods may be implement in creating floral arrangements for any event or situation. For example, the systems and methods may be used to create floral arrangements for corporate events, anniversaries, baby showers, birthdays, and the like.

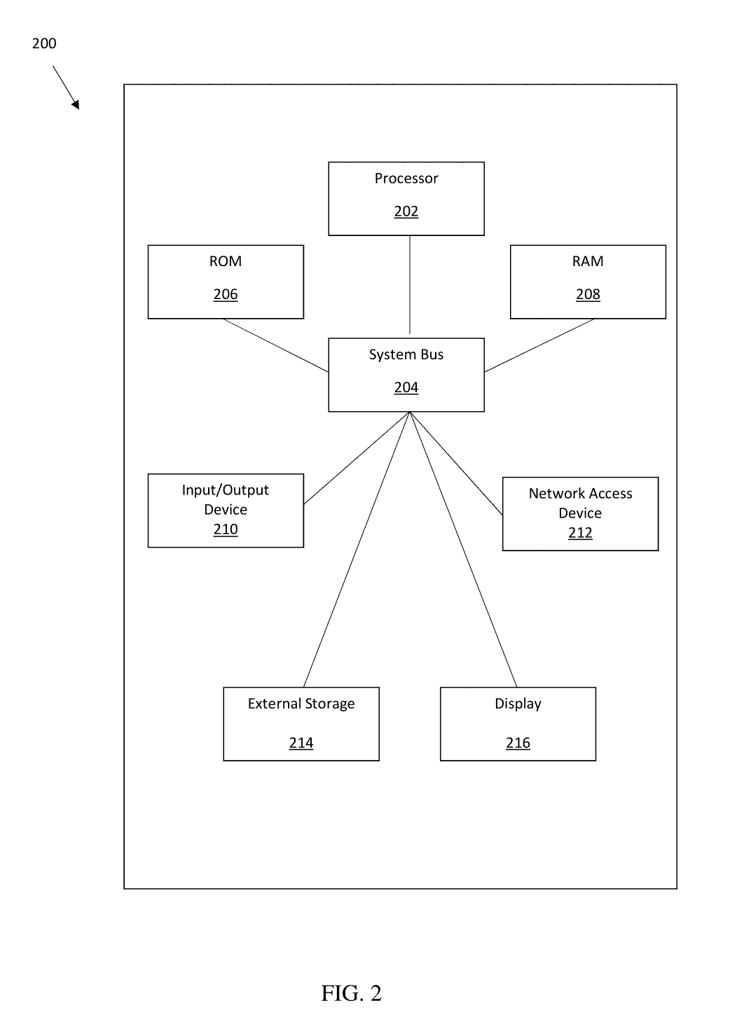

FIG. 2 is a high-level block diagram illustrating an example system environment for generating personalized floral arrangements according to the present disclosure. The system 200 is shown as a hardware device, but may be implemented in various forms of hardware, software, firmware, special purpose processors, or a combination thereof. Some embodiments are implemented in software as a program tangibly embodied on a program storage device. By implementing with a system or program, semi-automated or automated workflows are provided to assist a user in generating personalized health assessments.

The system 200 is a computer, personal computer, server, PACs workstation, mobile computing device, imaging system, medical system, network processor, network, or other now know or later developed processing system. The system 200 includes at least one processor 202 operatively coupled to other components via a system bus 204. The processor 202 may be, or may comprise, any suitable microprocessor or microcontroller, for example, a low-power application-specific controller (ASIC) and/or a field programmable gate array (FPGA) designed or programmed specifically for the task of controlling a device as described herein, or a general-purpose central processing unit (CPU). In one embodiment, the processor 202 may be implemented on a computer platform, wherein the computer platform includes an operating system and microinstruction code. The various processes, methods, acts, and functions described herein may be either part of the microinstruction code or part of a program (or combination thereof) which is executed via the operating system as discussed below.

The other components include memories (ROM 206 and/or RAM 208), a network access device 212, an external storage 214, an input/output device 210, and a display 216. Furthermore, the system 200 may include different or additional entities.

The input/output device 210, network access device 212, or external storage 214 may operate as an input operable to receive at least a portion of at least one of the genotypic information and the phenotypic measurements. Input may be received from a user or another device and/or output may be provided to a user or another device via the input/output device 210. The input/output device 210 may comprise any combinations of input and/or output devices such as buttons, knobs, keyboards, touchscreens, displays, light-emitting elements, a speaker, and/or the like. In an embodiment, the input/output device 210 may comprise an interface port (not shown) such as a wired interface, for example a serial port, a Universal Serial Bus (USB) port, an Ethernet port, or other suitable wired connection. The input/output device 210 may comprise a wireless interface (not shown), for example a transceiver using any suitable wireless protocol, for example Wi-Fi (IEEE 802.11), Bluetooth®, infrared, or other wireless standard. In an embodiment, the input/output device 210 may comprise a user interface. The user interface may comprise at least one of lighted signal lights, gauges, boxes, forms, check marks, avatars, visual images, graphic designs, lists, active calibrations or calculations, 2D interactive fractal designs, 3D fractal designs, 2D and/or 3D representations, and other interface system functions.

The network access device 212 allows the computing system 200 to be coupled to one or more remote devices (not shown) such as via an access point (not shown) of a wireless network, local area network, or other coupling to a wide area network, such as the Internet. In that regard, the processor 202 may be configured to share data with the one or remote devices via the network access device 212. The shared data may comprise, for example, genetic information, phenotypic information, genetic risk prediction data, and the like. In various exemplary embodiments, the network access device 212 may include any device suitable to transmit information to and from another device, such as a universal asynchronous receiver/transmitter (UART), a parallel digital interface, a software interface or any combination of known or later developed software and hardware. The network access device 212 provides a data interface operable to receive at least a portion of at least one of the genotypic information and the phenotypic measurements.

The processor 202 has any suitable architecture, such as a general processor, central processing unit, digital signal processor, application specific integrated circuit, field programmable gate array, digital circuit, analog circuit, combinations thereof, or any other now known or later developed device for processing data. The processor 202 may be a single device or include multiple devices in a distributed arrangement for parallel and/or serial processing. Likewise, processing strategies may include multiprocessing, multitasking, parallel processing, and the like. A program may be uploaded to, and executed by, the processor 202.

The processor 202 performs the workflows, data manipulation of the genetic information, integration of phenotypic measurements with the genotypic information and/or other processes described herein. The processor 202 operates pursuant to instructions. The genotypic information and the phenotypic measurements may be stored in a computer readable memory, such as the external storage 214, ROM 206, and/or RAM 208. The instructions for implementing the processes, methods and/or techniques discussed herein are provided on computer-readable storage media or memories, such as a cache, buffer, RAM, removable media, hard drive or other suitable data storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system. Because some of the constituent system components and method acts depicted in the accompanying figures may be implemented in software, the actual connections between the system components (or the process steps) may differ depending upon the manner of programming.

The external storage 214 may be implemented using a database management system (DBMS) managed by the processor 202 and residing on a memory, such as a hard disk, RAM, or removable media. Alternatively, the storage 214 is internal to the processor 202 (e.g. cache). The external storage 214 may be implemented on one or more additional computer systems. For example, the external storage 214 may include a data warehouse system residing on a separate computer system, a PACS system, or any other now known or later developed storage system.

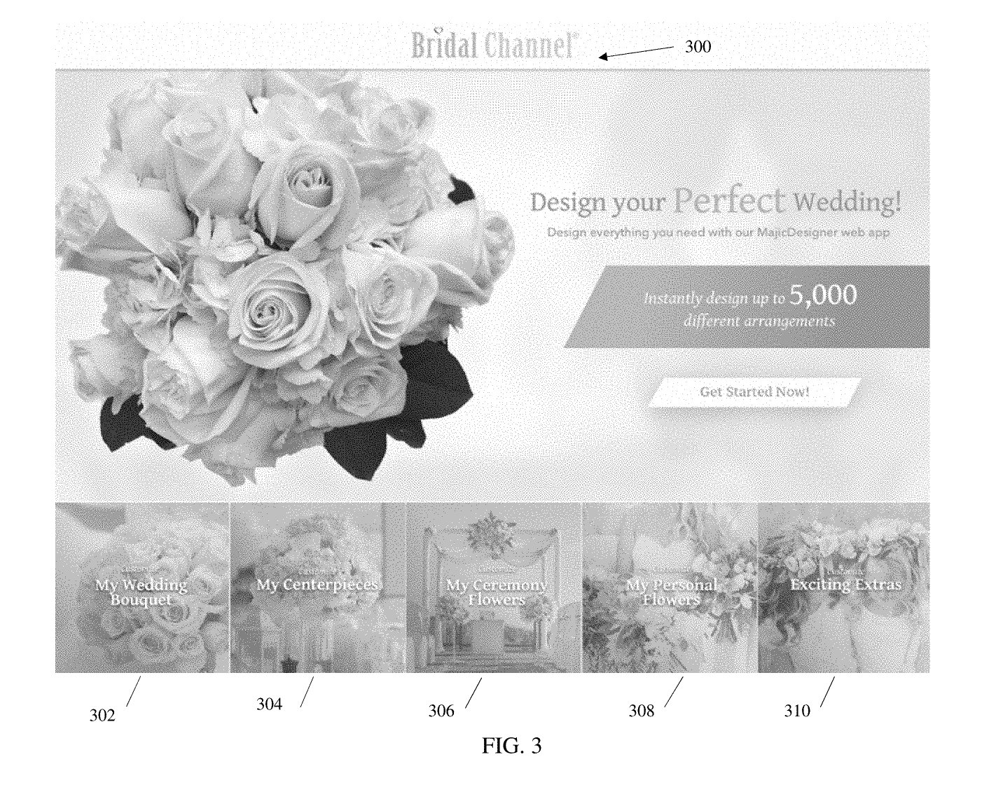

FIG. 3 illustrates an exemplary user interface 300 for the creation of a floral arrangement based on a template in accordance with an exemplary embodiment of the present invention. In an exemplary embodiment, the floral arrangement creation engine system 104 may interact with a user via exemplary user interface 300 displayed on the user device 102.

According to an exemplary embodiment, the exemplary user interface 300 first requires the user to input their name(s), date of ceremony, venue location, and chosen color scheme (collectively referred to as “user-provided identification data”). The exemplary user interface 300 provides this information, specifically the color scheme, as a point of reference for when the floral arrangement is created. The exemplary user interface 300 provides to the user for selection a plurality of floral arrangements; such as wedding bouquets 302, centerpieces 304, ceremony flowers 306, personal flowers 308, and other customized special floral arrangements desired the user. The user selects which floral arrangement to create and design. Upon selection of the desired floral arrangement, the user may then proceed to provide specific floral arrangement parameters for the selected floral arrangement.

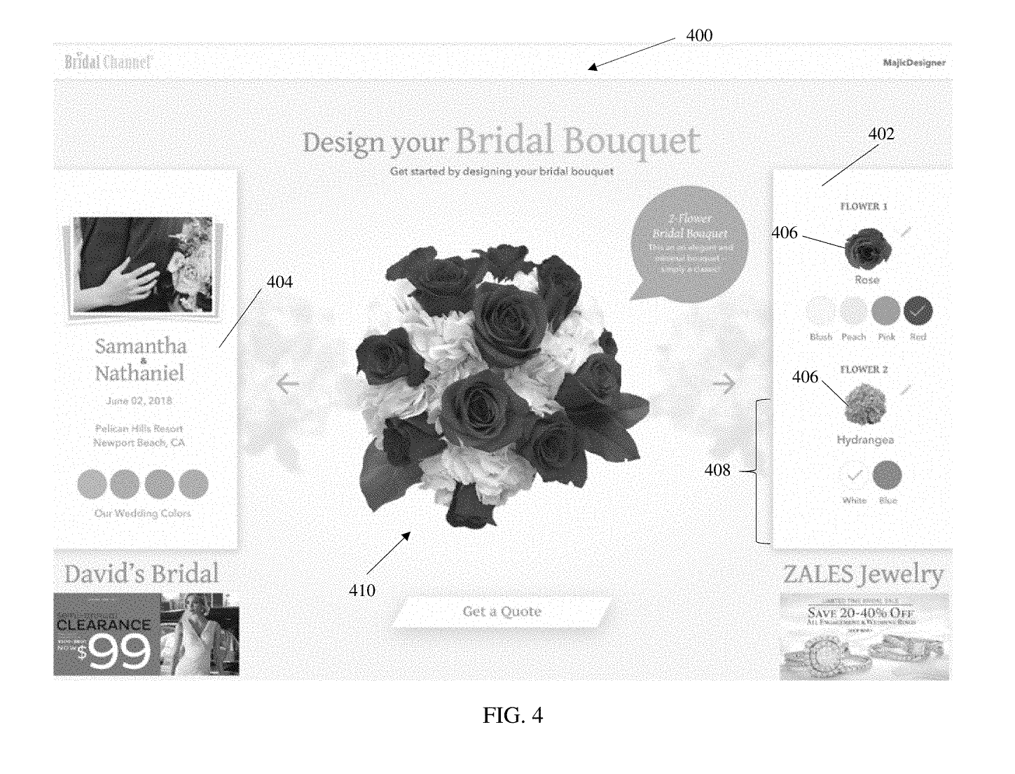

FIG. 4 illustrates an exemplary user interface 400 wherein the user may select desired floral arrangement parameters. The exemplary user interface 400 displays a template 402 of the selected floral arrangement, as well as the user-provided identification data 404, and provides a plurality of flower choices parameters with which to alter the template, thus creating the personalized floral arrangement. The flower choices parameters may include, but are not limited to, type of flowers, color of flowers, number of flowers, type of arrangement, and size of arrangement.

In an exemplary embodiment, each flower choice parameter may correspond to an image of the flower 406 in the template 402. According to an exemplary embodiment, the exemplary user interface 400 may also include a tab selection area in which users select to view line flowers, focal flowers, filler flowers and greenery. In an exemplary embodiment, the tab selection area may also include a tab for favorite flowers. According to an exemplary embodiment, when a user selects a tab in the tab selection area, the flower area 408 may update to display flowers of the flower type corresponding to the tab.

In an exemplary embodiment, the exemplary user interface 400 may also include a floral arrangement area 410. According to an exemplary embodiment, the floral arrangement area 410 may display a floral arrangement as designed by the user. In an exemplary embodiment, the user may drag-and-drop flower choices from the flower choice area (template 402) to the floral arrangement area 410.

According to an exemplary embodiment, the flower choice area 402 and floral arrangement area 410 may permit the user to see each flower and the entire floral arrangement in the precise manner in which the floral arrangement will be created. In an exemplary embodiment, the floral arrangement area 410 may offer the user a three-dimensional view of each flower and the ability to rotate the flower on its axis so the flower may be postured in the exact angle as in real-life. According to another exemplary embodiment, the exemplary user interface 402 may display a three-dimensional panoramic view of the bouquet so that the user may see the entire breadth and scope of the bouquet.

In an exemplary embodiment, the first type of flower to include in the floral arrangement may be a line flower. According to an exemplary embodiment, the exemplary user interface 400 may begin with highlighting the line flowers in the tab selection area and displaying line flowers in the flower choice area 402. In an exemplary embodiment, the exemplary user interface 400 may also display an outline of the template in the floral arrangement area 410. According to an exemplary embodiment, the exemplary user interface 400 may display the location line flowers will appear in the floral arrangement area 410 to the flower choice area 402.

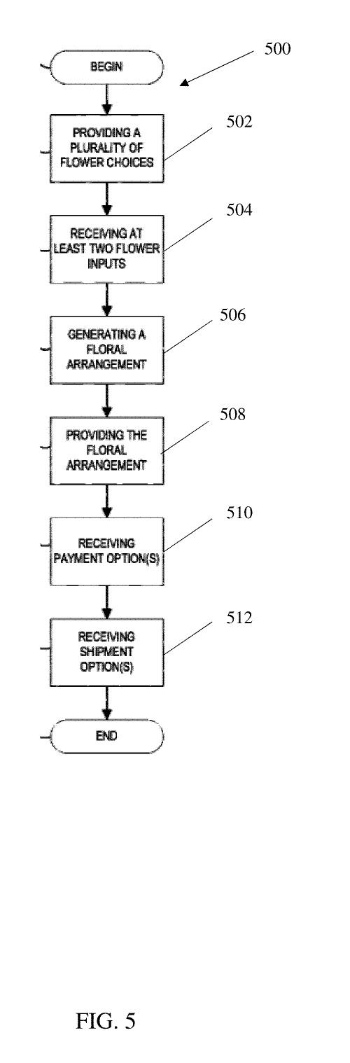

FIG. 5 illustrates a flowchart 500 of steps of the floral arrangement creation engine system 104 in accordance with an exemplary embodiment of the present invention. In an exemplary embodiment, flowchart may begin with and immediately continue with the step of providing a plurality of flower choices.

According to an exemplary embodiment, in the step of providing a plurality of flower choices the floral arrangement creation engine system 104 may provide a plurality of flower choices as shown at 502. In an exemplary embodiment, the floral arrangement creation engine system may provide a plurality of flower choices to a user via the user interface 106 displayed to the user through the user device 102, such as any suitable computing device known in the art.

At step 504, the floral arrangement creation engine system 104 receives at least two arrangement parameters from the user via the user interface 106. In an exemplary embodiment, an arrangement parameter may include, such as, e.g., but not limited to, a selection of a flower to include in a floral arrangement, a modification of an existing flower in a flower arrangement, a position to place a flower in an arrangement, and an orientation for a flower in an arrangement.

Upon receiving the at least two arrangement parameters, the floral arrangement creation engine system 104 may generate the floral arrangement based on the received flower input or other arrangement parameters as shown at 506. In an exemplary embodiment, the floral arrangement creation engine system 104 may generate a floral arrangement based on the flower type of the flower input. According to another exemplary embodiment, the floral arrangement creation engine system 104 may determine the flower type of the flower input based on data identifying the flower type associated with the flower input.

In an exemplary embodiment, the floral arrangement creation engine system 104 may determine at least one of a number or position of flowers to include in an arrangement based on the flower type of an arrangement parameter. As an example, if the floral arrangement creation engine system 104 receives an arrangement parameter of a long-stem rose, the floral arrangement creation engine system may determine the flower input corresponds to the flower type of line flower. In an exemplary embodiment, the floral arrangement creation engine system may pre-determine the number and position of flowers of a particular type in a floral arrangement. According to an embodiment, the pre-determinations may be at least one of pre-determined by a user, pre-determined according to templates, or pre-determined according to rules. In an exemplary embodiment, the floral arrangement creation engine system may generate a floral arrangement including the flower input of long-stem roses in the number and positions corresponding to line flowers in a floral.

According to another exemplary embodiment, generating the floral arrangement may include generating a floral suggestion for a user based on the flower type of the flower input. In one embodiment, a floral suggestion may include, such as, e.g., but not limited to, a position for the flower input, an orientation for the flower input, a color for the flower input, a size for the flower input, a type for the flower input, or an error suggestion. According to an exemplary embodiment, floral suggestions may provide suggestions to improve a floral arrangement based on one or more arrangement parameters from a user. In an exemplary embodiment, the floral arrangement creation engine system 104 may suggest modifications to existing flowers in a floral arrangement. According to an exemplary embodiment, the floral arrangement creation engine system 104 may determine the flower type associated with a location in the floral arrangement and determine if an arrangement parameter in the location corresponds to the flower type associated with the location. In an exemplary embodiment, if the flower type of the flower input does not correspond to the associated flower type, the floral arrangement creation engine system 104 may give a floral suggestion to the user to use a different flower in the location. According to an exemplary embodiment, the floral arrangement creation engine system 104 may suggest types of flowers to add to a floral arrangement based on the types of flowers already in a floral arrangement.

After generating a floral arrangement, the floral arrangement creation engine system 104 may provide the flower arrangement to the user as shown at 508. According to an exemplary embodiment, the floral arrangement creation engine system 104 may provide the flower arrangement by displaying a representation of the generated floral arrangement on the user device 102.

After providing the floral arrangement, the floral arrangement creation engine system 104 may provide the user with a plurality of florists 108 and/or payment options 110 as shown at 510. In choosing a florist and/or payment options, the floral arrangement creation engine system 104 may provide a plurality of florists 108 capable of preparing the desired floral arrangement as well as payment option(s) 110 for purchasing an actual floral arrangement based on the floral arrangement generated based on the flower input from the user.

In an exemplary embodiment, plurality of florists 108 may be based on the designed floral arrangement, budget restrictions, proximity to the user, and offered discounts. Payment options 110 may be forms of payments, such as, e.g., but not limited to, credit card, cellular phone applications, PayPal, gift certificate, or bank account, etc. According to an exemplary embodiment, the floral arrangement creation engine system 104 may present the user one or more of the above options of payment and the user may select one or more forms of payment using one or more of the options available from the floral arrangement creation engine system.

After choosing a florist and/or r payment options, the floral arrangement creation engine system 104 may receive shipment or delivery options as shown at 512. According to an exemplary embodiment, the floral arrangement creation engine system 104 may receive shipment or delivery options from a user for shipment or delivery information in shipping a purchased floral arrangement. In an exemplary embodiment, shipment options may include, such as, e.g., but not limited to, destination address, shipment carrier, shipment service type, signature requirement, or shipping insurance, etc. According to an exemplary embodiment, the floral arrangement creation engine system 104 may present available shipment options to the user and floral arrangement creation engine system may receive shipment options selected by the user.

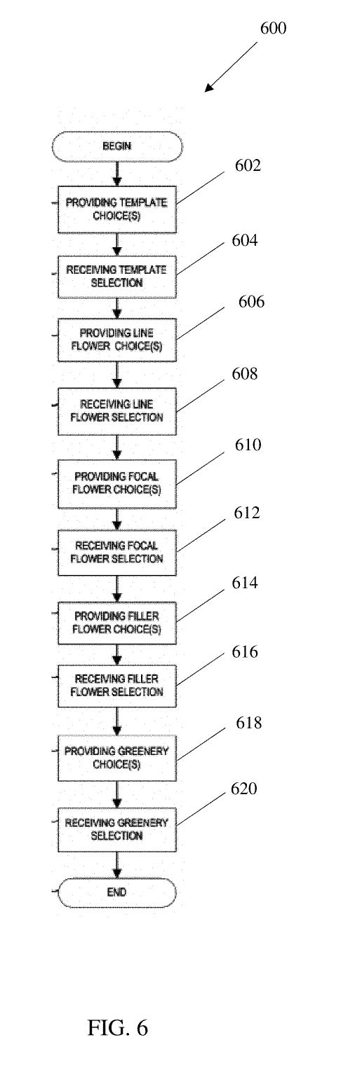

FIG. 6 illustrates a flowchart 600 of the creation of a floral arrangement based on a bouquet template in accordance with an exemplary embodiment of the present invention. According to an exemplary embodiment, at 602, the floral arrangement creation engine system 104 may provide one or more template choices to the user. According to one embodiment, the floral arrangement creation engine system 104 may provide a plurality of bouquet template choices to the user.

According to an exemplary embodiment, each bouquet template selection may have information associated with the template identifying a number and location of each type of flower in the bouquet template. The bouquet templates may include bridal bouquet arrangements, bridal party arrangements, centerpiece arrangements, reception entrance arrangements, and the like. In a preferred embodiment, when the bouquet templates are provided to the user, each template may appear as a rough sketch/outline of the template.

As shown at 604, the floral arrangement creation engine system 104 may receive a template selection from the user selecting one of the templates presented in the template choices. The floral arrangement creation engine system 104 then provides one or more-line flower choices to the user as shown at 606. The line flower choices available may be based on the template received in the template selection. At 608, the user may select a line flower to include in the floral arrangement from the choices. In one embodiment, a selection may include a drag-and-drop of a flower choice onto a depiction of the floral arrangement. In a preferred embodiment, the floral arrangement creation engine system 104 may include one or more-line flowers selected by the user in the arrangement based on the template selected. According to an exemplary embodiment, the floral arrangement creation engine system may select the number of line flowers and position of the line flowers to include in the floral arrangement based on the template selected.

At 610, the floral arrangement creation engine system 104 may provide one or more focal flower choices for the user. In an exemplary embodiment, the focal flower choices may be based on the template selected by the user. At 612, the floral arrangement creation engine system 104 may receive focal flower selections from the user. In one embodiment, the floral arrangement creation engine system 104 may include one or more focal flowers selected by the user in the arrangement based on the template selected. In a preferred embodiment, the floral arrangement creation engine system 104 may select the number of focal flowers and position of the focal flowers to include in the floral arrangement based on the template selected.

At 614, the floral arrangement creation engine system 104 may provide one or more filler flower choices for the user. In an exemplary embodiment, the filler flower choices may be based on the template selected by the user. At 616, the floral arrangement creation engine system 104 may receive a filler flower selection from the user. In one embodiment, the floral arrangement creation engine system 104 may include one or more filler flowers selected by the user in the arrangement based on the template selected. According to an exemplary embodiment, the floral arrangement creation engine system may select the number of filler flowers and position of the filler flowers to include in the floral arrangement based on the template selected.

At 618, the floral arrangement creation engine system 104 may provide one or more greenery choices for the user. In an exemplary embodiment, the greenery choices may be based on the template selected by the user. At 620, the floral arrangement creation engine system 104 may receive a greenery selection from the user. In one embodiment, the floral arrangement creation engine system 104 may include one or more greenery selected by the user in the arrangement based on the template selected. According to an exemplary embodiment, the floral arrangement creation engine system 104 may select the number of greenery and position of the greenery to include in the floral arrangement based on the template selected.

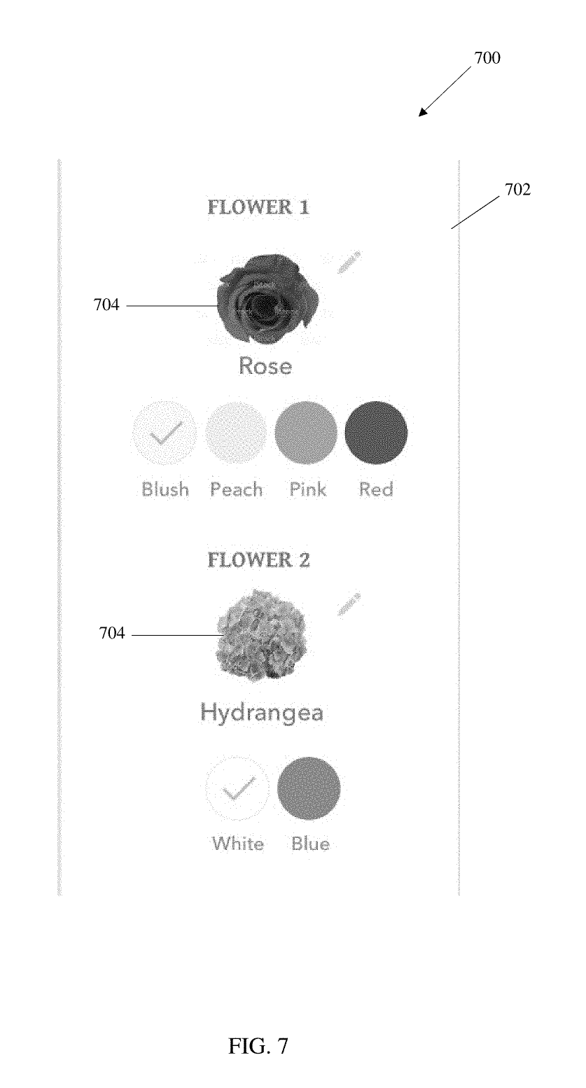

FIG. 7 illustrates an exemplary user interface 700 for the creation of a floral arrangement based on a bouquet template in accordance with an exemplary embodiment of the present invention. In one embodiment, the exemplary user interface 700 may include a flower choice area 702 depicting one or more flower choices for a user to choose a flower to include in a floral arrangement. In an exemplary embodiment, each flower choice may correspond to an image of the flower in the flower choice area as shown at 704. In one embodiment, the exemplary user interface 700 may also include a tab selection area in which users by select to view line flowers, focal flowers, filler flowers and greenery. In an exemplary embodiment, the tab selection may also include a tab for favorite flowers. According to an exemplary embodiment, when a user selects a tab in the tab selection area, the flower area may update to display flowers of the flower type corresponding to the tab.

In an exemplary embodiment, the first type of flower to include in the floral arrangement may be a line flower. According to an exemplary embodiment, the exemplary user interface 700 may begin with highlighting the line flowers in the tab selection area and displaying line flowers in the flower choice area 704. In an exemplary embodiment, the exemplary user interface 700 may also display an outline of the template in the floral arrangement area 410 as shown in FIG. 4. According to an exemplary embodiment, the exemplary user interface 700 may display the location line flowers will appear in the floral arrangement area according to the template.

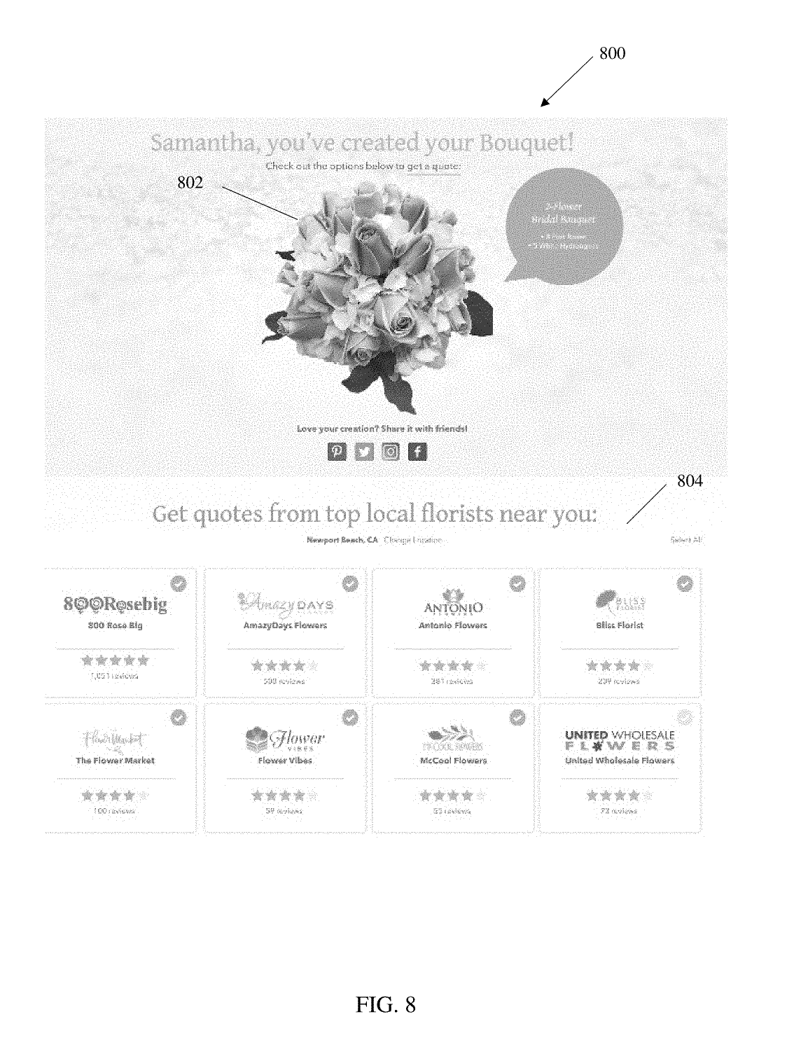

FIG. 8 illustrates exemplary user interface 800 for receiving a selection of florists, wherein at least one florist may generate a price quote via the quoting system 114 in accordance with an exemplary embodiment of the current disclosure. As shown in FIG. 8, the exemplary user interface 800 displays the selected floral arrangement 802. The exemplary user interface 800 further illustrates a plurality of florists as shown at 804 from which the user may select for receiving a price quote.

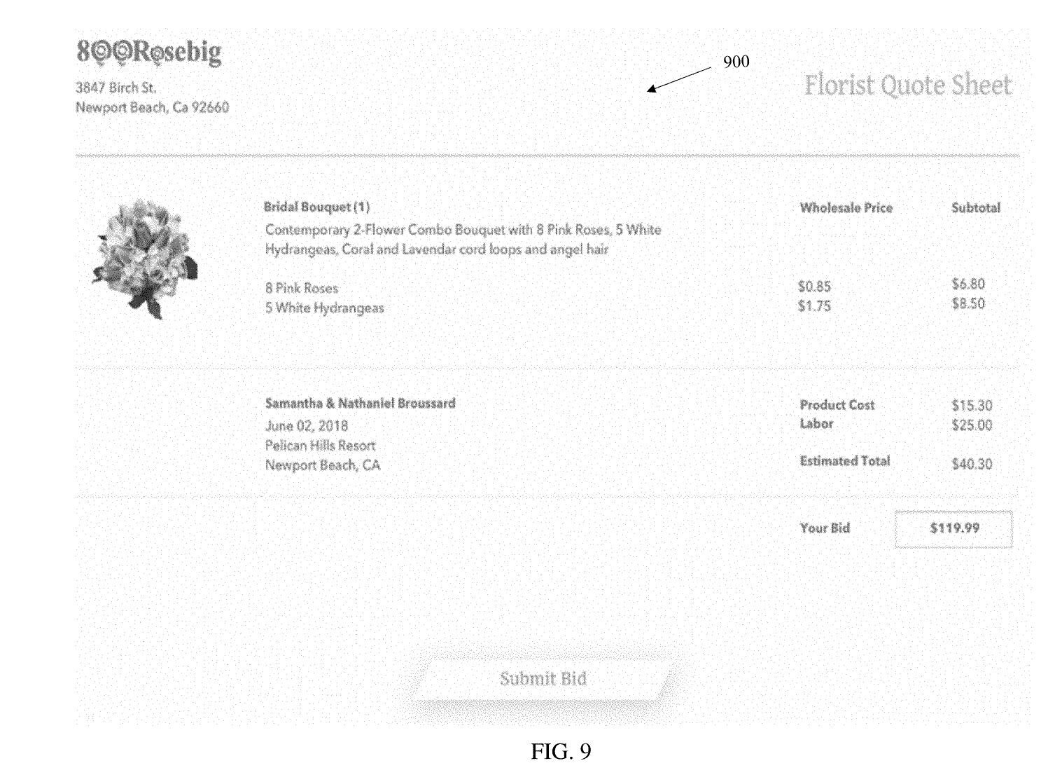

In operation, the quoting system 114 receives a quote request from the user. FIG. 9 illustrates an example price quote 900 from the user based on the selected floral arrangement. In response, the quoting system 114 determines a pricing scheme for the desired floral arrangement based on the floral arrangement parameters received from the user, generates a price quote based on the determined pricing scheme, and provides the generated quote to the user. The quoting system 114 includes a quoting engine 116, database 118, a matching engine 120, and a price quote preparation engine 122.

The database 118 stores information concerning various florists 108 and their product availability. Furthermore, the database 118 may store geographical maps, floral arrangements, information from florists 108, florist pricing rules, florist incentives, and communication templates. Such incentives may include, but are not limited to, money-back guarantees, cancellation insurance, promotional offers, and the like. The database 118 may include various translations understood to be a particular floral arrangement by the quoting engine 116.

Once an incoming price quote request is received from the user, a product description may be identified in the request and matched to a product description of one or more florists 108 by the matching engine 120. The price quote preparation engine 122 then prepares the corresponding price quote for presentation to the user. For example, the user may request a particular flower, while the quoting engine 116 understands the requested flower to be similar to other flowers. Because the descriptions are slightly different, the quoting engine 116 may map, translate, or otherwise understand that both descriptions apply to the same flower based on information stored under the database.

The matching is performed by the matching engine 118. Once an incoming price quote request is received from the user, a product description may be identified in the request and matched to a product description of one or more florists by the matching engine 118. The matching engine 118 uses the information stored in the mappings to determine what product is being requested by the user. In some embodiments, new and updated floral mappings may be added manually, automatically, or both, to the database 116. The database 116 may include information concerning specific floral arrangements. Such information may be expressed as any combination of options or features associated with a flower identified by the matching engine 118. In some embodiments, new and updated floral arrangements may be added to the database 116 due to the use of the quoting engine, just as new mappings may be added to the floral mappings.

The database 116 may include further information and specifications for a given floral arrangement. The information may provide the user with the selected floral arrangement's description as well as the descriptions of the options, features, and changes available and/or included on the quoted floral arrangement. For example, a user may request a particular floral arrangement, but be unaware of what further options and features are available. Such information may be accessed from the database 116 and provided to the user, who may then submit a new price quote request for the same floral arrangement, but with further changes concerning options, features, etc.

The database 116 may include lists of flowers currently at a given florist and/or from a florist wholesaler. The database 116 is used to provide information relating to actual new flowers and floral arrangements available from a particular florist or wholesaler that may match the price quote request submitted by the user. In some embodiments, available alternatives to the desired floral arrangement may be determined and presented to the user. Such alternatives may include higher-end floral arrangements, lower-end floral arrangements, as well as used/new alternatives. The information stored in the database 116 may be received from multiple florists in any geographic region.

The database 116 includes rules and the pricing values by which the florist arrives at the final price of a given floral arrangement. These rules are stored in advance of an incoming floral arrangement price quote request.

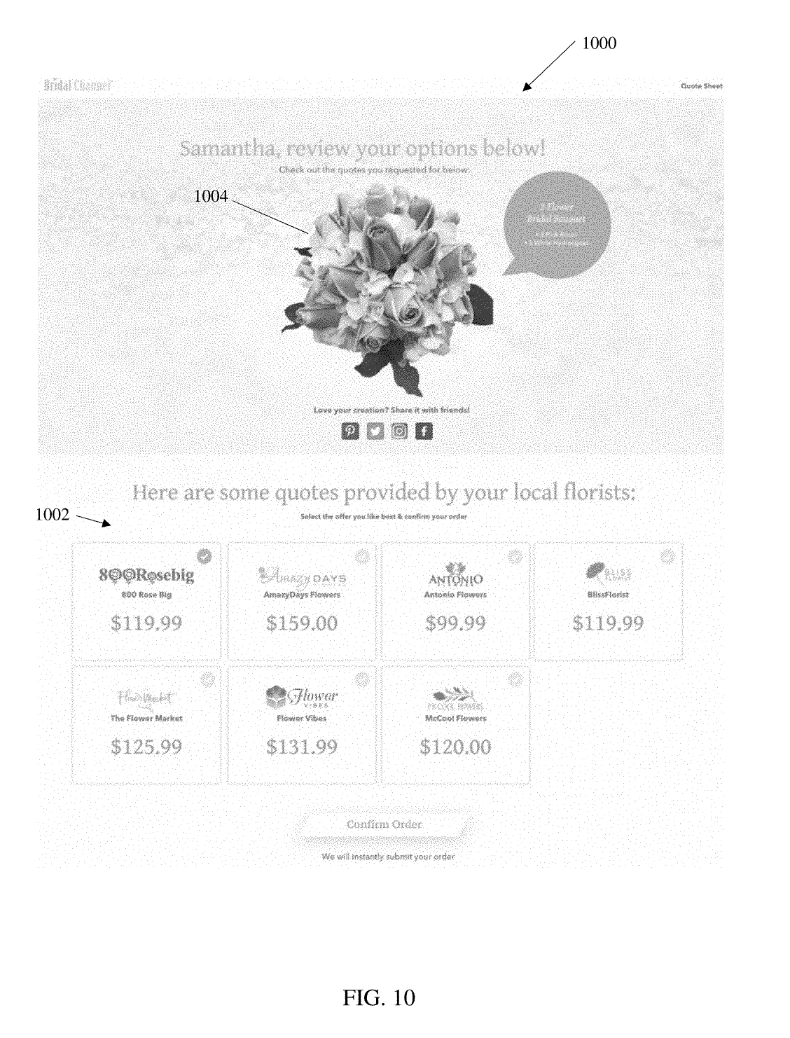

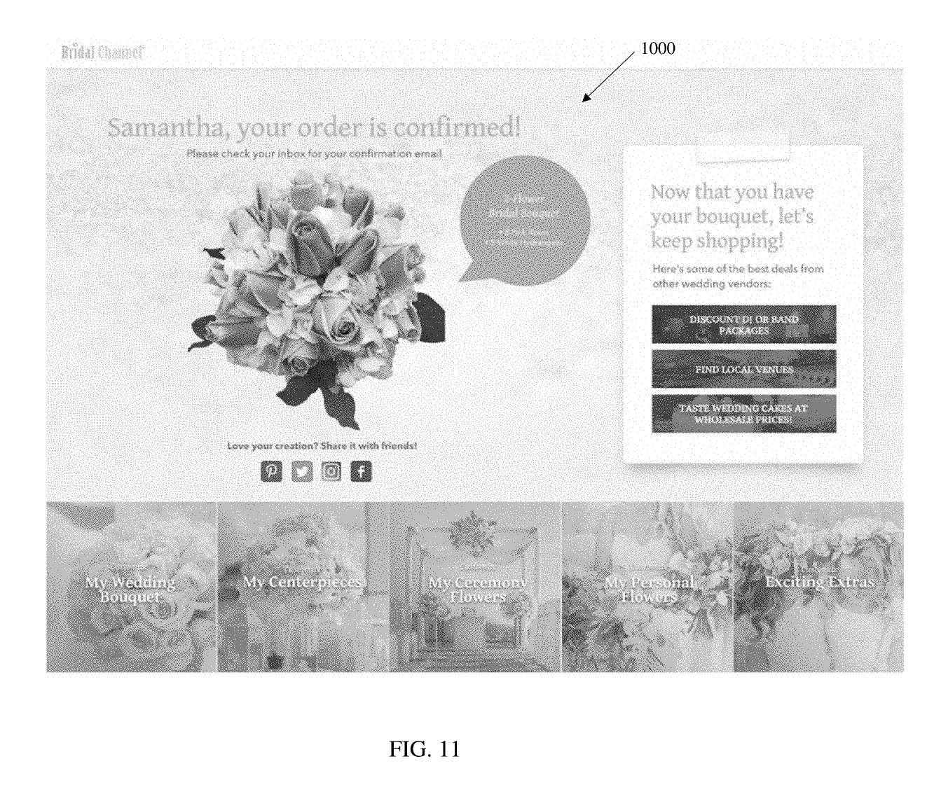

FIG. 10 illustrates an exemplary user interface 1000 providing price quotes from a plurality of florists 108 as shown at 1002 based on the selected floral arrangement as depicted at 1004. The user may select a florist from those provided to provide the selected floral arrangement. Once the user has selected a florist, the user may submit its order. FIG. 11 illustrates an example order confirmation 1100 from the selected florist based on the selected floral arrangement.

After receiving a florist selection and payment option, the floral arrangement creation engine system 104 may present available shipping and/or delivery options 112 for shipping the purchased floral arrangement to the user. In an exemplary embodiment, shipment options may include, such as, e.g., but not limited to, destination address, shipment carrier, shipment service type, signature requirement, or shipping insurance, etc.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. An interactive method for generating personalized floral arrangement via a computing system, wherein the computing system comprises
(a) a processor operable to control the computing system,
(b) data storage operatively coupled to the processor, wherein the data storage is configured to store a plurality of user identification data, florist data, flower pricing data, and combinations thereof,
(c) an input/output device operatively coupled to the processor, wherein the input/output device is configured to receive a plurality of data for transmission to the processor, wherein the input/output device is configured to transmit a plurality of data generated by the processor,
(d) a floral arrangement creation component operatively coupled to the processor and controlled in part by the processor, wherein the floral arrangement creation component is configured to create a plurality of floral arrangements, and
(e) a price quoting component operatively coupled to the processor and controlled in part by the processor, wherein the price quoting component is configured to generate a plurality of price quotes associated with creation of a plurality of floral arrangements, the method comprising:
receiving, via the input/output device, a request from a user device associated with a user to create at least one personalized floral arrangement, wherein the user request comprises user identification data associated with the user;
generating, by the floral arrangement creation component, a bouquet type template for presentation to the user via the user device, wherein the bouquet type template includes a plurality of bouquet template choices for creation of the at least one personalized floral arrangement;
receiving, via the input/output device, a bouquet template choice from the user;
generating, by the floral arrangement creation component, a bouquet flower template for presentation to the user via the user device, wherein the bouquet flower template includes a plurality of flower choices for the selected bouquet template;
receiving, via the input/output device, at least two flower inputs from the plurality of flower choices, wherein each of the at least two inputs comprises a flower type, wherein each flower type comprises at least one of a line flower, a focal flower, and a filler flower;
determining, by the floral arrangement creation component, positions for at least one of the at least two flower inputs;
designing, by the floral arrangement creation component, a floral arrangement based on the flower types of the flower inputs and the determined positions of the flower inputs; and
presenting, via the user device, a three-dimensional representation of the designed floral arrangement to the user.

2. The method of claim 1, further comprising:
obtaining a plurality of florist data associated with each of a plurality of florists, wherein the florist data for each florist includes at least one of florist experience data, florist location data, florist pricing data, florist flower availability data, and combinations thereof; and
obtaining a plurality of flower pricing data associated with a plurality of flower types.

3. The method of claim 2, further comprising:
generating, by price quoting component, based on at least a portion of the flower pricing data, at least one price estimate for the designed floral arrangement.

4. The method of claim 3, further comprising:
determining, by the floral arrangement creation component, based on at least a portion of the florist data, at least one florist capable of providing the designed floral arrangement;
providing, via the user device, florist data associated with the at least one capable florist to the user.

5. The method of claim 4, further comprising:
receiving from the user, via the input/output device, selection data for at least one florist to provide the designed floral arrangement;
transmitting to the at least one selected florist, via the input/output device, the designed floral arrangement data, price estimate data, and user identification data.

6. The method of claim 5, further comprising:
receiving from at least one selected florist, via the input/output device, capability data associated with providing the designed floral arrangement and at least one price quote therefore;
presenting, via the user device, the capability data and the at least one price quote from the at least one florist.

7. The method of claim 1, wherein designing the floral arrangement comprises generating a floral suggestion for the user based on the flower type of at least one of the flower inputs, wherein the floral suggestion comprises at least one of calculating an orientation for the at least one flower input, determining a color of the at least one flower input, determining a size for the at least one flower input, determining a type for the at least one flower input, and providing an error message.

8. The method of claim 7, wherein generating the floral suggestion is based on at least one of the position or orientation of the at least one flower input.

9. The method of claim 1, further comprising:
receiving from the user, via the input/output device, at least one modification to at least one flower input;
dynamically adjusting, via the floral arrangement creation component, the designed floral arrangement based on the at least one modification.

10. The method of claim 1, wherein the bouquet type template comprises a plurality of theme bouquet templates for theme-based occasions.

11. An interactive computing system for generating personalized floral arrangements, the computing system comprising:
a processor operable to control the computing system;
data storage operatively coupled to the processor, wherein the data storage is configured to store a plurality of user identification data, florist data, flower pricing data, and combinations thereof;
an input/output device operatively coupled to the processor, wherein the input/output device is configured to receive a plurality of data for transmission to the processor, wherein the input/output device is configured to transmit a plurality of data generated by the processor;
a floral arrangement creation component operatively coupled to the processor and controlled in part by the processor, wherein the floral arrangement creation component is configured to create a plurality of floral arrangements; and
a price quoting component operatively coupled to the processor and controlled in part by the processor, wherein the price quoting component is configured to generate a plurality of price quotes associated with creation of a plurality of floral arrangements;
wherein the floral arrangement creation component is further operable to:
receive, from the input/output device, a request from a user device associated with a user to create at least one personalized floral arrangement, wherein the user request comprises user identification data associated with the user;
generate a bouquet type template for presentation to the user via the user device, wherein the bouquet type template includes a plurality of bouquet template choices for creation of the at least one personalized floral arrangement;
receive, via the input/output device, a bouquet template choice from the user;
generate a bouquet flower template for presentation to the user via the user device, wherein the bouquet flower template includes a plurality of flower choices for the selected bouquet template;
receive, via the input/output device, at least two flower inputs from the plurality of flower choices, wherein each of the at least two inputs comprises a flower type, wherein each flower type comprises at least one of a line flower, a focal flower, and a filler flower;
determine component, positions for at least one of the at least two flower inputs;
design a floral arrangement based on the flower types of the flower inputs and the determined positions of the flower inputs; and
present, via the user device, a three-dimensional representation of the designed floral arrangement to the user.

12. The system of claim 11,
wherein the data storage is operable to store a plurality of florist data associated with each of a plurality of florists and a plurality of flower pricing data associated with a plurality of flower types, wherein the florist data for each florist includes at least one of florist experience data, florist location data, florist pricing data, florist flower availability data, and combinations thereof.

13. The system of claim 12, wherein the price quoting component is further operable to generate, based on at least a portion of the flower pricing data, at least one price estimate for the designed floral arrangement.

14. The system of claim 13, wherein the floral arrangement creation component is further operable to:
determine, based on at least a portion of the florist data, at least one florist capable of providing the designed floral arrangement;
provide, via the user device, florist data associated with the at least one capable florist to the user.

15. The system of claim 14, wherein the floral arrangement creation component is further operable to:
receive from the user, via the input/output device, selection data for at least one florist to provide the designed floral arrangement;
transmit to the at least one selected florist, via the input/output device, the designed floral arrangement data, price estimate data, and user identification data.

16. The system of claim 15, wherein the floral arrangement creation component is further operable to:
receive from at least one selected florist, via the input/output device, capability data associated with providing the designed floral arrangement and at least one price quote therefore;
present, via the user device, the capability data and the at least one price quote from the at least one florist.

17. The system of claim 11, wherein the floral arrangement creation component is further operable to generate a floral suggestion for the user based on the flower type of at least one of the flower inputs, wherein the floral suggestion comprises at least one of calculating an orientation for the at least one flower input, determining a color of the at least one flower input, determining a size for the at least one flower input, determining a type for the at least one flower input, and providing an error message.

18. The system of claim 17, wherein the floral suggestion is generated based on at least one of the position or orientation of the at least one flower input.

19. The system of claim 11, wherein the floral arrangement creation component is further operable to:
Receive from the user, via the input/output device, at least one modification to at least one flower input;
dynamically adjust the designed floral arrangement based on the at least one modification.

20. The system of claim 11, wherein the bouquet type template comprises a plurality of theme bouquet templates for theme-based occasions.
